(19) United States
(12) Patent Application Publication
(10) Pub. No.: US 2015/0156814 A1
(43) Pub. Date: Jun. 4, 2015

(54) CROSS-LAYER OPTIMIZATION METHOD IN A MULTIMEDIA TRANSMISSION SYSTEM

(71) Applicant: HUMAX Holdings Co., Ltd., Yongin (KR)

(72) Inventors: Chungku YIE, Incheon (KR); Min Sung KIM, Anyang (KR); Ul Ho LEE, Hwaseong (KR)

(21) Appl. No.: 14/616,065

(22) Filed: Feb. 6, 2015

Related U.S. Application Data
(63) Continuation-in-part of application No. 13/812,401, filed on Jan. 25, 2013.

(30) Foreign Application Priority Data
Jul. 27, 2010 (KR) 10-2010-0072156

(51) Int. Cl. H04W 80/06; H04W 72/04

(52) U.S. Cl. CPC H04W 80/06; H04W 72/04

(57) ABSTRACT

Disclosed are cross-layer optimization method where information about lots of dynamic changes in wireless environment is shared and cross-layer optimization is implemented through abstraction layer component. Multimedia transport layer operating method where optimization of first layer and second layer is implemented by using service information provided from first layer having transport layer and network layer and second layer having datalink layer and physical layer. The operating method includes upward abstraction step where service information provided to second layer is processed and processed service information is provided to multimedia transport layer and downward abstraction step where indication information provided from multimedia transport layer is processed and processed service information is provided to second layer. Consequently, there is advantage that all layers share diverse information about lots of dynamic changes in wireless environment, and the diverse information can be controlled to allow transmission where QoS is ensured more effectively.

### CROSS-REFERENCE TO RELATED APPLICATIONS

The present application is a continuation-in-part of U.S. patent application Ser. No. 13/812,401 filed on Jan. 25, 2013, which is a National Stage of International Patent Application No. PCT/KR2011/005537 filed on Jul. 27, 2011, which claims priority to Korean Patent Application No. 10-2010-0072156 filed on Jul. 27, 2010, the disclosures of which are hereby incorporated in their entirety by reference.

### TECHNICAL FIELD

The present invention relates to a multimedia transmission system and, more particularly, to a cross-layer optimization method.

### BACKGROUND ART

Since the standardization of MPEG-2, new standards for video encoding standard (or an audio encoding standard) have been steadily developed into MPEG-4, H.264/AVC, and Scalable Video Coding (SVC) in the last 10 years. Furthermore, each of the new standards has made a new market and widened the application scope of the MPEG standard. Transmission technology, such as MPEG-2 Transport System (TS), however, has been widely used in digital broadcasting and mobile broadcasting (T-DMB, DVB-H, etc.) in the market during the past 20 years without change. The transmission technology has been widely utilized even in multimedia transmission over the Internet, i.e. IPTV service, which had not been considered when the MPEG-2 TS standard was established.

However, a multimedia transmission environment when the MPEG-2 TS was developed and a current multimedia transmission environment have been significantly varied. For example, the MPEG-2 TS standard was developed by considering the transmission of multimedia data over an ATM network, but it has become difficult to find use cases where the MPEG-2 TS standard is used for this purpose. Furthermore, the MPEG-2 TS standard includes factors that are not efficient for recent multimedia transmission over the Internet because requirements, such as requirements for multimedia transmission via the Internet, were not taken into consideration when the MPEG-2 TS standard was developed. Accordingly, in MPEG, the establishment of an MPEG Multimedia Transport Layer (MMT), that is, a new multimedia transmission standard which is suitable for a varying multimedia environment and into which multimedia service through the Internet has been taken into consideration, is recognized as a very important problem.

As described above, MMT standardization is ongoing because the MPEG2-TS standard completed 20 years ago has not been optimized for the recent IPTV broadcasting service, Internet environment, etc. For this reason, in MPEG, the MMT has been standardized as a new transmission technology standard according to an urgent need for a multimedia transmission international standard that is optimized in a multimedia transmission environment in a variety of recent heterogeneous networks.

In a conventional wireless Ad-hoc network field, as a cross-layer optimization method, there is Korean Patent Laid-Open Publication No. 2007-0090718 (Title of the Invention “OPTIMIZATION METHOD AND OPTIMIZATION APPARATUS FOR QUEUE-BASED CROSS-LAYER IN WIRELESS AD-HOC NETWORK”, an applicant Samsung Electronics Co., Ltd.).

### DISCLOSURE

### Technical Problem

When a multimedia stream is transmitted over a wireless communication network, and not over a wired communication network, physical medium characteristics, such as the data transmission rate, can vary depending on the characteristics and environments of the radio transmission medium. As a result, radio channel characteristics of a transmission terminal (e.g., transmitter) and/or radio channel characteristics of a reception terminal (e.g., receiver) deteriorate when the transmitted multimedia is not adjusted due to the variation of the radio channel characteristics and/or the bandwidth.

In some embodiments, the systems and methods described herein performs cross-layer optimization by sharing information associated with various dynamic variations in a wireless transmission environment.

In some embodiments, the systems and methods described herein provide an abstraction layer for abstracting the cross-layer optimization within the wireless environment.

### Technical Solution

In one aspect, a method performed by a multimedia transport system for transmitting multimedia data, the method includes receiving, in a multimedia transport layer of the multimedia transport system, multimedia data to be transmitted to a receiver, mapping, in an abstraction layer of the multimedia transport system that is in data communication with the multimedia transport layer, service information provided by a second layer of the multimedia transport system onto service information of the multimedia transport layer, processing, in the abstraction layer, indication information provided by the multimedia transport layer that is based on the service information of the second layer, providing the processed indication information to the second layer and transmitting, via a data link layer of the second layer, the multimedia data to the receiver based on the provided indication information. In some examples, the multimedia data transmitted to the receiver has a data format and transmission protocol defined by the multimedia transport layer.

In some examples, the transmission protocol is defined based on HTTP protocol or RTP/RTCP protocol by the multimedia transport layer.

In some examples, the second layer provides service information that varies dynamically depending on characteristics of a communication network.

In some examples, the communication network is a network capable of transmitting and receiving multimedia data provided by the multimedia transport layer.

In some examples, the second layer changes, based on the indication information, service information that is provided when the multimedia data is transmitted to the receiver.

In some examples, the multimedia transport layer performs cross-layer optimization when the multimedia transport layer is applied to a mobile terminal and a Universal Mobile Telecommunication Network Terrestrial Radio Access Network (UMTS) wireless network.

In another aspect, a computer-readable storage medium whose contents, when executed by a computing system, cause the computing system to perform operations for transmitting multimedia data to a receiver, the operations includes receiving, in a multimedia transport layer of the multimedia transport system, multimedia data to be transmitted to a receiver, mapping, in an abstraction layer of the multimedia transport system that is in data communication with the multimedia transport layer, service information provided by a second layer of the multimedia transport system onto service information of the multimedia transport layer, processing, in the abstraction layer, indication information provided by the multimedia transport layer that is based on the service information of the second layer, providing the processed indication information to the second layer and transmitting, via a data link layer of the second layer. In some examples, the multimedia data to the receiver based on the provided indication information, the multimedia data transmitted to the receiver having a data format and transmission protocol defined by the multimedia transport layer.

### Advantageous Effects

In performing cross-layer optimization (e.g., by sharing information between layers in a multimedia transmission system via an abstraction layer within the layers), the systems and methods described herein may provide efficient transmission of multimedia data with guaranteed or high Quality of Service (QoS), because information associated with various dynamic variations in a wireless environment are shared by the layers, enabling a multimedia system to control the shared information and adjust the transmitted data accordingly. Furthermore, in cases where a multimedia transmission protocol for transmitting multimedia data is defined, there are advantages in that the multimedia transmission protocol does not need to be modified depending on dynamic variation in a wireless environment because the multimedia transmission protocol is defined based on information shared between layers. Furthermore, when multimedia data are transmitted using cross-layer optimization, there is advantage in that network resources can be efficiently used according to the characteristics of the multimedia data to be transmitted.

### BRIEF DESCRIPTION OF THE DRAWINGS

FIGS. 1 to 3 are block diagrams showing protocol layer structures for multimedia transmission when an MPEG Multimedia Transport (MMT) layer whose standardization is now in progress will be introduced.

FIG. 4 is a block diagram when a cross-layer optimization method is applied to the protocol layer structure of FIG. 3 in a multimedia transmission system in accordance with a first exemplary embodiment of the present invention.

FIG. 5 is a block diagram showing a wireless interface protocol layer structure according to a Third Generation Partnership Project (3GPP) UMTS wireless access network standard.

FIG. 6 is a block diagram when a cross-layer optimization method is applied to the wireless interface protocol layer structure according to the 3GPP wireless access network standard of FIG. 5 in a multimedia transmission system in accordance with a second exemplary embodiment of the present invention.

FIG. 7 is a block diagram illustrating a construction of a multimedia transmission system according to an embodiment of the present invention.

### BEST MODE

The present invention may be modified in various ways and may have several exemplary embodiments. Specific exemplary embodiments of the present invention are illustrated in the drawings and described in detail in the detailed description. It should be however understood that the present invention is not limited to the specific exemplary embodiments and the present invention includes all modifications, equivalents to substitutions, which fall within the spirit and technical scope of the present invention. The same reference numbers are used throughout the drawings to refer to the same or like parts.

Terms, such as the first, the second, A, and B, may be used to describe various elements, but the elements should not be restricted by the terms. The terms are used to only distinguish one element from the other element. For example, a first element may be named a second element without departing from the scope of the present invention. Likewise, a second element may be named a first element. A term ‘and/or’ includes a combination of a plurality of relevant and described items or any one of a plurality of related and described items.

When it is said that one element is described as being “connected” or “coupled” to the other element, one element may be directly connected or coupled to the other element, but it should be understood that another element may be present between the two elements. In contrast, when it is said that one element is described as being “directly connected” or “directly coupled” to the other element, it should be understood that another element is not present between the two elements.

Terms used in this application are used to only describe specific exemplary embodiments and are not intended to restrict the present invention. An expression referencing a singular value additionally refers to a corresponding expression of the plural number, unless explicitly limited otherwise by the context. In this application, terms, such as “comprise” or ‘have”, are intended to designate those characteristics, numbers, steps, operations, elements, or parts which are described in the specification, or any combination of them that exist, and it should be understood that they do not preclude the possibility of the existence or possible addition of one or more additional characteristics, numbers, steps, operations, elements, or parts, or combinations thereof.

All terms used herein, including technical or scientific terms, unless otherwise defined, have the same meanings, which are typically understood by those having ordinary skill in the art. The terms, such as ones defined in common dictionaries, should be interpreted as having the same meanings as terms in the context of pertinent technology, and should not be interpreted as having ideal or excessively formal meanings unless clearly defined in the specification.

Embodiments of the present invention are described in detail below with reference to the accompanying drawings.

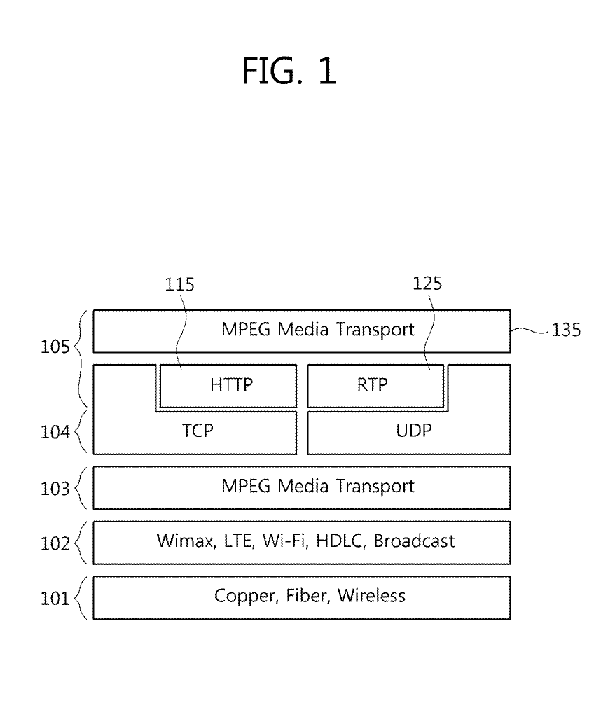

First, a protocol layer structure for the media transmission of an MPEG Multimedia Transport layer, hereinafter abbreviated as an ‘MMT’) whose standardization is now in progress is described with reference to FIGS. 1 to 3.

FIGS. 1 to 3 are block diagrams showing protocol layer structures for multimedia transmission when an MMT layer whose standardization is now in progress will be introduced.

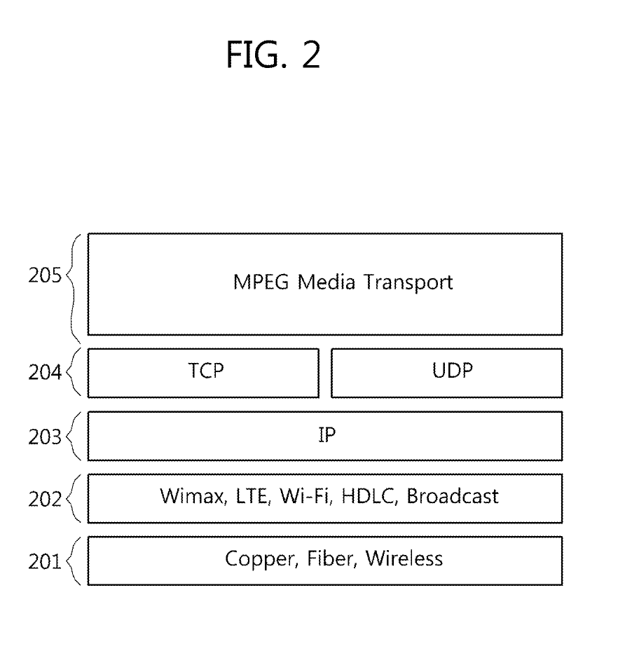

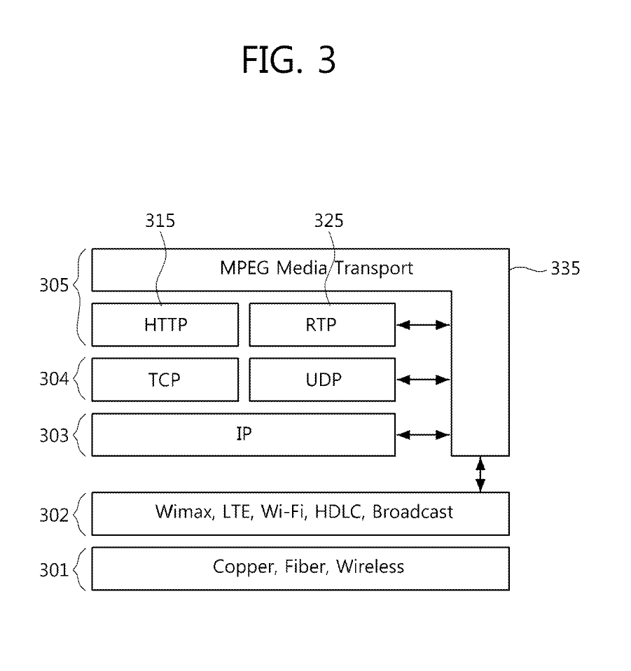

That is, FIG. 1 is a first form of a protocol layer structure when an MMT 135 whose standardization is now in progress will be introduced. FIG. 2 is a second form of a protocol layer structure when an MMT 205 will be introduced, and FIG. 3 is a third form of a protocol layer structure when an MMT 335 will be introduced. The structures do not have a mutual exclusive or inclusive relationship and have independent forms. In a current MPEG standardization meeting, it is expected that standardization will be performed in the order of the first form of FIG. 1, the second form of FIG. 2, and the third form of FIG. 3.

Referring to FIGS. 1 to 3, the protocol layer structure when the MMT will be applied can include a physical layer 101, a data link layer 102, a network layer 103, a transport layer 104, and an application layer 105. The application layer 105 can be configured to include the MMT 135 as shown in FIG. 1 and can be configured to include the MMT 135, an HTTP protocol 115 or an RTP/RTCP protocol 125 as shown in FIG. 1.

In the case where a large amount of multimedia data is transmitted in real time, the application layer 105 and the network layer 103 require a function of supporting the real-time transmission of the multimedia data, and the requirement requires a requirement for supporting Quality of Service (QoS). Furthermore, there is a need for a method for supporting QoS over all the layers so that the real-time transmission is possible while overcoming a relatively small bandwidth and unstable channel state in a wireless network.

The application layer 105 and the network layer 103 have used transmission methods having strong error recovery in order to support this QoS, for example, Forward Error Correction (FEC), Automatic Repeat Request (ARQ), and interleaving. The Internet designed to have a hierarchical structure as in FIGS. 1 to 3 has a great influence on the design of the structure of a wireless network having a hierarchical form. However, the hierarchical structure is not efficient in handling many dynamic changes in a wireless environment and is also not efficient in optimizing the performance of a wireless network.

Accordingly, as shown in FIG. 3, a multimedia transport layer 335 has a structure for optimizing the performance of a wireless network by performing optimization by way of direct control of the transport layer 304, the network layer 303, and the data link layer 302.

This technology can be called Cross Layer Optimization (CLO) or inter-layer optimization. This technology refers to technology in which a transmission network does not have the same characteristics or properties from the start point to the end point of transmission and multimedia transmission is adaptively optimized depending on the characteristics of each lower transport layer at a point where the transmission characteristics or properties are changed by considering the fact that QoS is not constantly guaranteed.

For this optimization, if the multimedia transport layer 335 directly controls the transport layer 304, the network layer 303, and the data link layer 302, the transmission process of the multimedia transport layer 335 may be adaptively changed, depending on service information provided by each layer.

However, the process of the multimedia transport layer 335 cannot be changed adaptively with respect to the service information provided by the data link layer 302, because the service information provided by the data link layer 302 may vary depending on a communication method (IEEE802.11 WLAN, WiMax, LTE, etc.). As a result, problems may occur when an MMT layer needs to be modified depending on a communication method used by a lower layer, such as the data link layer or the physical layer, and the MMT layer may be differently implemented depending on the communication method because service information may vary depending on the communication method.

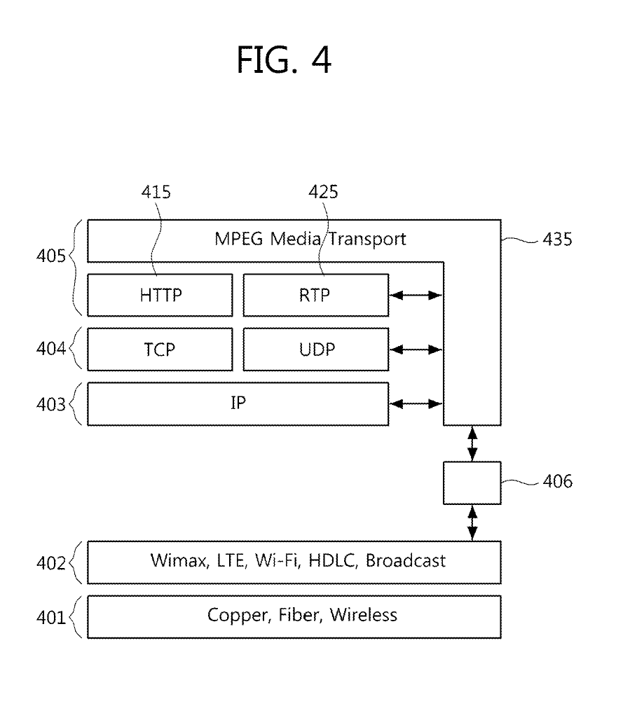

FIG. 4 is a block diagram when a cross-layer optimization method is applied to the protocol layer structure of FIG. 3 in a multimedia transmission system in accordance with a first exemplary embodiment of the present invention.

Referring to FIG. 4, the protocol layer structure includes a first layer, a second layer, an application layer 405, and an abstraction layer 406. The first layer includes a network layer 403 and a transport layer 404, the second layer includes a physical layer 401 and a data link layer 402, and the application layer 405 includes a multimedia transport layer 435, an HTTP protocol layer 415, and an RTP/RTCP protocol layer 425.

The multimedia transport layer 435 can receive service information from lower layers, for example, the HTTP protocol layer 415, the transport layer 404, and/or the network layer 403. Furthermore, the multimedia transport layer 435 can perform cross-layer optimization using the service information received from the HTTP protocol 415, the RTP/RTCP protocol 425, the transport layer 404, and the network layer 403.

In accordance with the first exemplary embodiment of the present invention, the multimedia transport layer 435 defines a multimedia transmission protocol based on the HTTP protocol 415 or the RTP/RTCP protocol 425 provided by the transport layer 404. Accordingly, when multimedia data is transmitted based on the multimedia transmission protocol, cross-layer optimization can be performed, because the multimedia transmission protocol does not need to be changed depending on the service information of the lower layers.

In accordance with the first exemplary embodiment of the present invention, the transport layer 404 determines a multimedia transmission channel based on information on a transmission channel that is selected based on the characteristics or properties of an IP-based communication network, and sends information on the determined transmission channel to the multimedia transport layer 435. The multimedia transport layer 435 selects a transmission channel through which multimedia data will be transmitted based on the service information provided by the network layer 403. Thus, the multimedia transport layer 435 does not need to change a multimedia transmission protocol depending on the service information of the network layer 403 when multimedia data is transmitted.

In accordance with the first exemplary embodiment of the present invention, a communication network denotes all communication networks, for example, an IP-based wired network and an IP-based wireless network through which multimedia data provided by the multimedia transport layer 435 can be transmitted and received. The IP-based wired network is, for example, the Internet. The IP-based wired network has an open type computer network structure which provides a TCP/IP protocol and several services present in upper layers over the TCP/IP protocol, for example, HTTP, Telnet, a File Transfer Protocol (FTP), a Domain Name System (DNS), a Simple Mail Transfer Protocol (SMTP), a Simple Network Management Protocol (SNMP), Network File Service (NFS), and Network Information Service (NIS). The IP-based wireless network performs a function of guaranteeing the mobility of a mobile terminal, a handover function, and a function of managing radio resources and includes a WLAN (IEEE 802.11 a/b/g, etc.), WiBro, a public switched telephone network, and mobile communication networks, such as Code Division Multiple Access (hereinafter referred to as ‘CDMA’) and Orthogonal Frequency Division Multiplexing (OFDM), but not limited thereto.

The network layer 403 has a function of performing routing, allocating an address, and selecting a network interface, and an IP handoff function of maintaining IP connectivity with an external network. The network layer 403 provides the multimedia transport layer 435 with mobile IP handoff initialization/completion events and a network interface that is now being used. In accordance with the first exemplary embodiment of the present invention, the multimedia transport layer 435 can change a channel used to transmit multimedia data according to a channel condition by modifying a multimedia transmission protocol so that an optimal path that will be used when multimedia data is transmitted is selected based on service information provided by the network layer 403.

The data link layer 402 can be data link layers of various high-speed wireless data packet communication protocols, such as Wi-Max, High-Level Data Link Control (HDLC), broadcast, Wi-Fi, and Long Term Evolution (LTE). A protocol used in the data link layer 402 from the time when multimedia data starts being transmitted to the time when the transmission of the multimedia data to a reception terminal is completed when the multimedia data is transmitted/received is dynamically changed depending on the characteristics or properties of a mobile communication network.

Accordingly, in accordance with the first exemplary embodiment of the present invention, the multimedia transport layer 435 receives service information from the data link layer 402, and cross-layer optimization is performed when the multimedia transport layer 435 uses the received service information. The service information provided by the data link layer 402, however, has not been standardized, and thus the service information of the multimedia transport layer 435 cannot be dynamically modified using the received service information.

In contrast, in accordance with the first exemplary embodiment of the present invention, the cross-layer optimization can be performed by incorporating the service information provided by the transport layer 404 and the network layer 403, into the service information provided by the multimedia transport layer 435 because the service information provided by the transport layer 404 and the network layer 403 has been standardized. In accordance with the first exemplary embodiment of the present invention, if the service information provided by the transport layer 404 and the network layer 403 is dynamically changed depending on the characteristics or properties of a communication network, the multimedia transport layer 435 can receive the service information from the transport layer 404 and the network layer 403 and adaptively modify its service information by standardizing the service information provided by the transport layer 404 and the network layer 403.

Furthermore, the physical medium characteristics of service information provided by the physical layer 401 are abruptly changed, depending on the characteristics and environments of the radio transmission medium. Accordingly, the multimedia transport layer 435 receives service information provided by the physical layer 401 and has to modify its service information using the received service information. However, the physical layer 401 has not been standardized like the data link layer 402. Accordingly, the multimedia transport layer 435 receives the service information from the physical layer 401, but cannot dynamically modify its service information using the received service information.

The multimedia transport layer 435 can provide indication information to the HTTP protocol layer 415, the transport layer 404, and the network layer 403. Furthermore, the multimedia transport layer 435 can provide the indication information to at least one layer of the data link layer 402 and the physical layer 401 through the abstraction layer 406. In accordance with the first exemplary embodiment of the present invention, when the multimedia transport layer 435 provides indication information, such as a multimedia transmission protocol, for example, a multimedia data format, a protocol used in multimedia data, and the amount of multimedia data transmitted per second, to the network layer 403, the network layer 403 can select a transmission channel based on the instruction information received from the multimedia transport layer 435.

The multimedia transport layer 435 can receive service information provided by at least one layer of the data link layer 402 and the physical layer 401 through the abstraction layer 406. In accordance with the first exemplary embodiment of the present invention, since the service information provided by the data link layer 402 and the physical layer 401 can have a variety of forms depending on an adopted communication method, that is, the service information has not been standardized, the multimedia transport layer 435 cannot directly perform cross-layer optimization using the service information provided by the data link layer 402 or the physical layer 401. Accordingly, the multimedia transport layer 435 performs cross-layer optimization using the service information of a lower layer that is provided through the abstraction layer 406.

That is, the abstraction layer 406 performs functions of mapping the service information provided by the data link layer 402 and/or the physical layer 401, onto the service information that can be used by the multimedia transport layer 435. A process in which the multimedia transport layer 435 performs cross-layer optimization is described in detail below.

The multimedia transport layer 435 uses the abstraction layer 406 in order to perform optimization on the first layer and the second layer using pieces of service information provided by the first layer and the second layer. In accordance with the first exemplary embodiment of the present invention, the abstraction layer 406 performs two types of functions. First, the abstraction layer 406 performs an upward abstraction function of processing service information provided by the second layer and sending the processed service information to the multimedia transport layer 435. In accordance with an exemplary embodiment of the present invention, the data link layer 402 of the second layer can include high-speed wireless data packet communication protocols, such as Wi-Max, HDLC, broadcast, Wi-Fi, and LTE, and a protocol used in the data link layer 402 from the start of the transmission of multimedia data until the end of the transmission of the multimedia data to a reception terminal when the multimedia data is transmitted/received is dynamically changed depending on the characteristics or properties of a mobile communication network.

Moreover, when a protocol used in the data link layer 402 from the start of the transmission of multimedia data until the end of the transmission of the multimedia data to a reception terminal when the multimedia data is transmitted/received, physical medium characteristics, such as the data transmission rate, may change, depending on the characteristics or properties and environments of the radio transmission medium of the physical layer 401. In order to adapt to the changing radio channel, the multimedia transport layer 435 can perform optimization by receiving service information provided by the second layer from the abstraction layer 406, for example, a bandwidth that varies due to the characteristics or properties of a radio channel and the occurrence of traffic concentration abruptly changing due to the characteristics or properties of a mobile communication network and a change in the number of users within a cell and data transmission rate and a physical medium characteristics varying depending on the characteristics and environment of the radio transmission medium. Accordingly, the multimedia transport layer 435 can perform optimization on the first layer and the second layer using the service information transmitted by and received from the abstraction layer 406.

Second, the abstraction layer 406 performs a downward abstraction function of processing indication information provided by the multimedia transport layer 435 and providing the processed indication information to the second layer. In accordance with an exemplary embodiment of the present invention, the type of multimedia data provided by the multimedia transport layer 435 can include digital/analog multimedia data, high-picture quality multimedia data, moving image multimedia data, etc., and the multimedia transport layer 435 defines indication information, for example, a multimedia transmission protocol, such as a standard for multimedia data, a protocol in which the multimedia data is transmitted, and the amount of the multimedia data transmitted per second, depending on the type of multimedia data.

Accordingly, the multimedia transport layer 435 can perform optimization on the first layer and the second layer by sending the indication information to the second layer through the abstraction layer 406.

For example, the multimedia transport layer may perform optimization of the transport of multimedia data to be transmitted to a receiver by: mapping, in an abstraction layer in data communication with the multimedia transport layer, service information provided by the second layer onto service information of the multimedia transport layer, processing, in the abstraction layer, indication information of the multimedia transport layer that is based on the service information of the second layer, and providing the processed indication information to the second layer, which transmits, via a data link layer of the second layer, the multimedia data to the receiver based on the provided indication information.

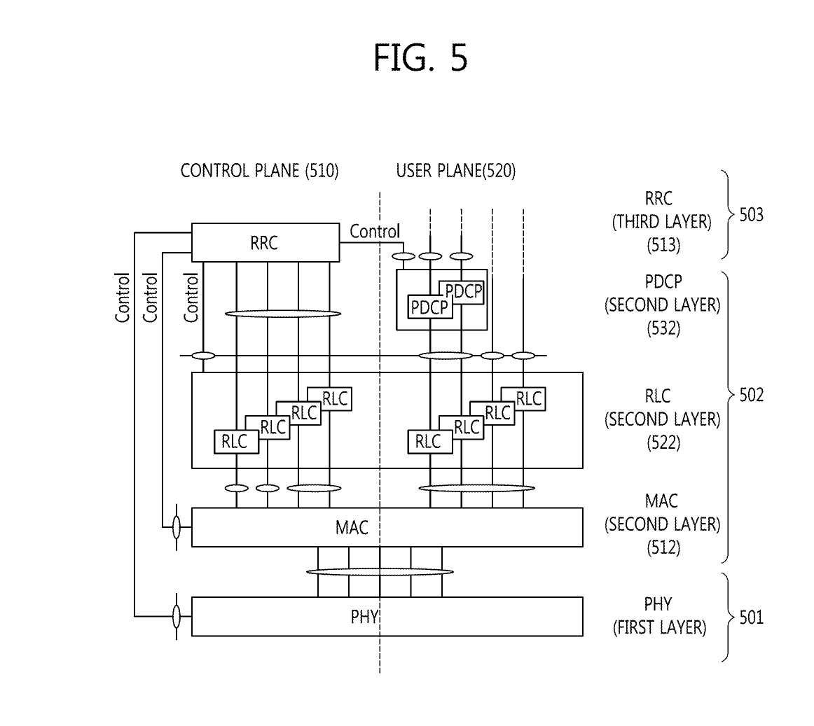

A wireless interface protocol layer structure according to a Third Generation Partnership Project (3GPP) wireless access network standard is described in detail below with reference to FIG. 5.

### MODE FOR INVENTION

FIG. 5 is a block diagram showing a wireless interface protocol layer structure according to a 3GPP wireless access network standard.

Referring to FIG. 5, the wireless interface protocol between a mobile terminal and a UMTS wireless network (Universal Mobile Telecommunication Network Terrestrial Radio Access Network (UTRAN)), vertically, can be configured to include a physical layer 501, a data link layer 502, and a network layer 503, and horizontally can be configured to include a control plane 510 for transferring a control signal and a user plane 520 for transmitting data information.

The control plane can be configured to include a Radio Resource Control (hereinafter referred to as ‘RRC’) layer 513, a Radio Link Control (hereinafter referred to as ‘RLC’) layer 522, a Medium Access Control (hereinafter referred to as ‘MAC’) layer 512, and a physical layer 501, and the user plane can be configured to include a Packet Data Convergence Protocol (hereinafter referred to as ‘PDCP’) layer 532, the RLC layer 522, the MAC layer 512, and the physical layer 501.

The physical layer 501 provides information transfer service to an upper layer using various types of wireless transmission technologies. The physical layer 501 and the MAC layer 512, that is, an upper layer of the physical layer 501, are coupled through a transport channel, and data is transferred between the MAC layer 512 and the physical layer 501 through the transport channel. The transport channel is divided into a dedicated transport channel and a common transport channel depending on whether the transport channel can be exclusively used by a user or can be shared by several terminals.

The MAC layer 512 provides the reallocation service of an MAC parameter for the allocation and reallocation of radio resources. The MAC layer 512 is connected to the RLC layer 522 through logical channels, and various logical channels are provided depending on the type of provided information. In general, when the information of the control plane is transmitted, a control channel is used, and when the information of the user plane is transmitted, a traffic channel is used.

The RLC layer 522 provides the setup and release service of a radio link. Furthermore, the RLC layer 522 performs a function of segmenting and concatenating an RLC Service Data Unit (hereinafter referred to as an SDU) downloaded from an upper layer of the user plane. The size of the RLC SDU is adjusted according to a processing capacity in the RLC layer 522, header information is added to the RLC SDU, and the RLC SDU is then transferred to the MAC layer 512 in the form of a Protocol Data Unit (hereinafter abbreviated as a PDU).

The PDCP layer 532 is located at a position higher than the RLC layer 522, and the PDCP layer 532 enables data transmitted through a network protocol, such as IPv4 or IPv6, to be transmitted in a form suitable for the RLC layer 522. Furthermore, the PDCP layer 532 reduces unnecessary control information used in a wired network so that data can be efficiently transmitted through a wireless interface. This function is called header compression. For example, this function can be used to reduce the amount of header information for TCP/IP.

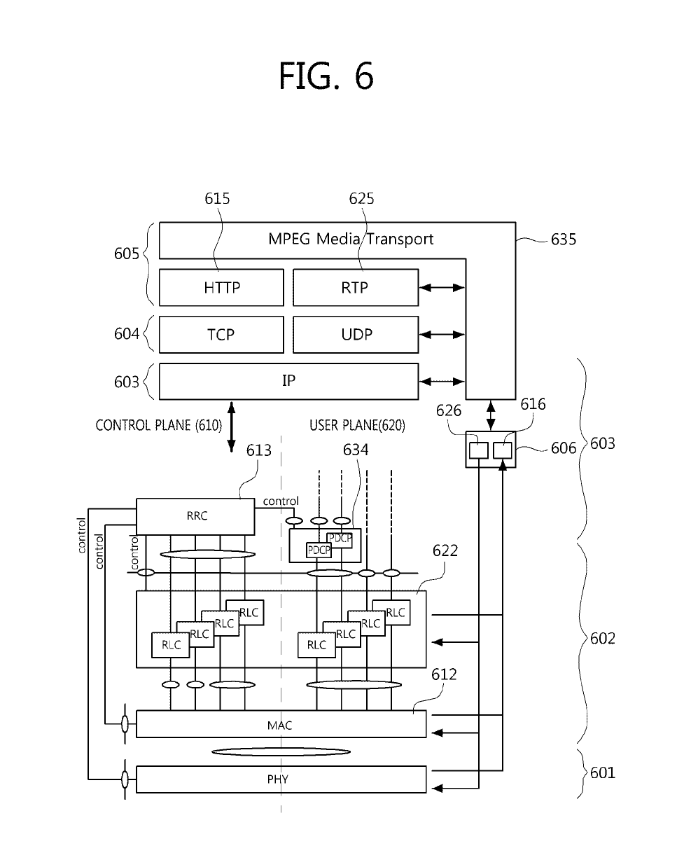

The RRC layer 513 provides information broadcast service for broadcasting information to all terminals that are located in a specific area. Furthermore, the RRC layer 513 is responsible for control plane signal processing for the exchange of control signals in a third layer, and the RRC layer 513 has a function of setting, maintaining, and releasing radio resources between UTRANs. In particular, the RRC has a function of setting, maintaining, and releasing a radio bearer and a function of allocating, rearranging, or releasing radio resources, which is necessary to access the radio resources. Here, the radio bearer refers to service that is provided by the second layer for the transfer of data between a terminal and the UTRAN. That is, the configuration of one radio bearer means a process of defining the characteristics of a protocol layer and a channel necessary to provide a specific service and setting a detailed parameter and operation method. A case where a cross-layer optimization method in a multimedia transmission system in accordance with a second exemplary embodiment of the present invention is applied to a wireless interface protocol between a mobile terminal and a UTRAN is described in more detail below with reference to FIG. 6.

FIG. 6 is a block diagram when a cross-layer optimization method is applied to the wireless interface protocol layer structure according to the 3GPP wireless access network standard of FIG. 5 in a multimedia transmission system in accordance with the second exemplary embodiment of the present invention.

Referring to FIG. 6, a wireless interface protocol for transmitting multimedia data between a mobile terminal or device and a UTRAN can be configured to include a first layer, a second layer, an application layer 605, and an abstraction layer 606, horizontally. The first layer can be configured to include a network layer 603 and a transport layer 604, the second layer can be configured to include a physical layer 601 and a data link layer 602, the application layer 605 can be configured to include an HTTP protocol layer 615 and an RTP/RTCP protocol layer 625, and the abstraction layer 606 can be configured to include an upward abstraction component 616 and a downward abstraction component 626. The wireless interface protocol between a mobile terminal and a UTRAN can be configured to include a control plane 610 for transferring a control signal and a user plane 620 for transmitting data vertically. The control plane can be configured to include an RRC layer 613, an RLC layer 622, an MAC layer 612, and a physical layer 601, and the user plane can be configured to include a PDCP layer 634, the RLC layer 622, the MAC layer 612, and the physical layer 601.

The application layer 605 is the highest layer and is a layer for executing a protocol for managing a user and a network operator and enabling communication between a user and a central processing unit.

The multimedia transport layer 635 of the application layer 605 can receive service information provided by lower layers, for example, the HTTP protocol layer 615, the transport layer 604, and the network layer 603. Furthermore, the multimedia transport layer 635 can perform cross-layer optimization using service information received from the HTTP protocol layer 615, the RTP/RTCP protocol layer 625, the transport layer 604, and the network layer 603. In accordance with the second exemplary embodiment of the present invention, the multimedia transport layer 635 defines a multimedia transmission protocol based on the HTTP protocol layer 615 or the RTP/RTCP protocol layer 625 provided by the transport layer 604. Accordingly, cross-layer optimization can be performed because the multimedia transmission protocol does not need to be changed depending on the service information of a lower layer when multimedia data is transmitted based on the multimedia transmission protocol.

In accordance with the second exemplary embodiment of the present invention, the transport layer 604 determines a multimedia transmission channel based on information on a transmission channel that is selected depending on the characteristics or properties of an IP-based communication network and sends information on the determined transmission channel to the multimedia transport layer 635. In response thereto, the multimedia transport layer 635 selects a transmission channel through which multimedia data will be transmitted based on service information provided by the network layer 603. Thus, the multimedia transport layer 635 does not need to change the multimedia transmission protocol depending on the service information of the network layer 603 when multimedia data is transmitted.

In accordance with the second exemplary embodiment of the present invention, a communication network denotes all communication networks, for example, an IP-based wired network and an IP-based wireless network, which can transmit and receive multimedia data provided by the multimedia transport layer 635. The IP-based wired network is, for example, the Internet. The IP-based wired network has an open type computer network structure, which provides a TCP/IP protocol and several services present in upper layers over the TCP/IP protocol, for example, HTTP, Telnet, an FTP, a DNS, an SMTP, an SNMP, NFS, and NIS. The IP-based wireless network performs a function of guaranteeing the mobility of a mobile terminal, a handover function, and a function of managing radio resources and includes a WLAN, WiBro, a public switched telephone network, and mobile communication networks (e.g., 2/3/4 generation mobile communication network based on CDMA or OFDM), but not limited thereto.

The network layer 603 has a function of performing routing, allocating an address, and selecting a network interface, and an IP handoff function of maintaining IP connectivity with an external network. The network layer 603 provides the multimedia transport layer 635 with mobile IP handoff initialization/completion events and a network interface that is now being used. In accordance with the second exemplary embodiment of the present invention, the multimedia transport layer 635 can change a channel used to transmit multimedia data according to a channel condition by modifying a multimedia transmission protocol so that an optimal path that will be used when multimedia data is transmitted is selected based on service information provided by the network layer 603.

Furthermore, the RRC layer 613 of the network layer 603 provides the multimedia transport layer 635 with information broadcast service for broadcasting information to all terminals located in a specific area. In particular, the RRC layer 613 has a function of setting, maintaining, and releasing a radio bearer and a function of allocating, rearranging, or releasing radio resources which is necessary to access the radio resources. The meaning that the RRC layer 613 configures a radio bearer refers to a process of defining the characteristics or properties of a protocol layer and a channel necessary to provide a specific service and of setting a detailed parameter and operation method. Accordingly, in accordance with the second exemplary embodiment of the present invention, the multimedia transport layer 635 receives service information, for example, radio bearer information provided by the RRC layer 613 and performs cross-layer optimization by modifying its service information using the received radio bearer information.

The MAC layer 612 provides the reallocation service of an MAC parameter for the allocation and reallocation of radio resources. The MAC layer 612 is connected to the RLC layer 622 through logical channels, and various logical channels are provided depending on the type of provided information. In general, when the information of the control plane is transmitted, a control channel is used, and when the information of the user plane is transmitted, a traffic channel is used. In accordance with an exemplary embodiment of the present invention, the multimedia transport layer 635 receives service information from the MAC layer 612 and performs cross-layer optimization by using the received service information. However, the transmission process of the multimedia transport layer 635 cannot be changed dynamically and adaptively using service information provided by the data link layer 602 because the received service information has not been standardized.

The physical layer 601 provides information transfer service information to an upper layer using various types of wireless transmission technologies. The physical layer 601 and the MAC layer 612, that is, an upper layer of the physical layer 601, are coupled through a transport channel, and data is moved between the MAC layer 612 and the physical layer 601 through the transport channel. The transport channel is divided into a dedicated transport channel and a common transport channel depending on whether the transport channel can be exclusively used by a user or can be shared by several terminals. However, service information provided by the physical layer 601 has not been standardized like in the data link layer 602. Accordingly, the multimedia transport layer 635 receives service information from the physical layer 601 and cannot modify its service information using the received service information dynamically.

The multimedia transport layer 635 can provide indication information to the HTTP protocol layer 615, the transport layer 604, and the network layer 603. Furthermore, the multimedia transport layer 635 can provide the indication information to at least one layer of the RLC layer 622, the MAC layer 612, and PHY layer 601 through the abstraction layer 606. In accordance with the second exemplary embodiment of the present invention, when the multimedia transport layer 635 provides indication information, such as a multimedia transmission protocol, for example, a multimedia data format, a protocol used in multimedia data, and the amount of multimedia data transmitted per second, to the network layer 603, the network layer 603 can select a transmission channel based on the indication information received from the multimedia transport layer 635.

The multimedia transport layer 635 can receive service information provided by at least one layer of the RLC layer 622, the MAC layer 612, and PHY layer 601 through the abstraction layer 606. In accordance with the second exemplary embodiment of the present invention, since the service information provided by the RLC layer 622, the MAC layer 612, and PHY layer 601 has not been standardized, the multimedia transport layer 635 cannot perform cross-layer optimization using the service information provided by the RLC layer 622, the MAC layer 612, and PHY layer 601. Accordingly, the multimedia transport layer 635 performs cross-layer optimization using the service information of a lower layer that is provided through the abstraction layer 606. A process in which the multimedia transport layer 635 performs cross-layer optimization is described in more detail below.

The multimedia transport layer 635 uses the abstraction layer 606 in order to perform optimization on the first layer and the second layer using pieces of service information provided by the first layer and the second layer. In accordance with an exemplary embodiment of the present invention, the abstraction layer 606 performs two types of functions. First, the upward abstraction component 616 of the abstraction layer 606 performs an upward abstraction function of processing service information provided by the second layer and sending the processed service information to the multimedia transport layer 635. In accordance with an exemplary embodiment of the present invention, the abstraction layer 606 performs an upward abstraction function of processing service information provided by at least one layer of the MAC layer 612 of the data link layer 602, the PLC layer 622, and the physical layer 601 and sending the processed service information to the multimedia transport layer 635.

In accordance with an exemplary embodiment of the present invention, the abstraction layer 606 performs the upward abstraction function of processing parameter information provided by the MAC layer 612, for example, MAC_DATA_IND indicative of the service information of the MAC layer 612 and a parameter MAC_State_IND indicative of the state of the MAC layer 612 and sending the processed parameter information to the multimedia transport layer 635. Accordingly, the multimedia transport layer 635 performs mapping the parameter information of the multimedia transport layer 635 based on the parameter information of the MAC layer 612 received through the abstraction layer 606.

Furthermore, in accordance with an exemplary embodiment of the present invention, when the abstraction layer 606 performs the upward abstraction function of processing parameter information provided by the RLC layer 622, for example, a parameter RLC_AM_DATA_CNF, informing the success of transmission, and sending the processed parameter information to the multimedia transport layer 635, the multimedia transport layer 635 can know that the transmission of multimedia data has been successfully completed based on the parameter information of the RLC layer 622 received through the abstraction layer 606.

Second, the downward abstraction component 626 of the abstraction layer 606 performs the downward abstraction function of processing indication information provided by the multimedia transport layer 635 and providing the processed indication information to the second layer. In accordance with an exemplary embodiment of the present invention, the type of multimedia data provided by the multimedia transport layer 635 can include digital/analog multimedia data, high-picture quality multimedia data, moving image multimedia data, etc. The multimedia transport layer 635 defines a multimedia transmission protocol, such as a standard for multimedia data, a protocol in which the multimedia data is transmitted, and the amount of multimedia data transmitted per second, depending on the type of multimedia data.

Here, the multimedia transmission protocol defined by the multimedia transport layer 635 is or is part of indication information provided to the second layer from the multimedia transport layer 635 via the abstraction layer 606. Accordingly, the second layer receives the indication information from the abstraction layer 606 and dynamically determines a transmission service, used in the data link layer 602 and the physical layer 601, based on the received indication information.

Thus, in some embodiments, the multimedia transmission system receives, in a multimedia transport layer of the multimedia transport system, multimedia data to be transmitted to a receiver, the multimedia data having a defined data format and transmission protocol, maps, in an abstraction layer of the multimedia transport system that is in data communication with the multimedia transport layer, service information provided by a second layer of the multimedia transport system onto service information of the multimedia transport layer, processes, in the abstraction layer, indication information provided by the multimedia transport layer that is based on the service information of the second layer, provides the processed indication information to the second layer, and transmits, via a data link layer of the second layer, the multimedia data to the receiver based on the provided indication information.

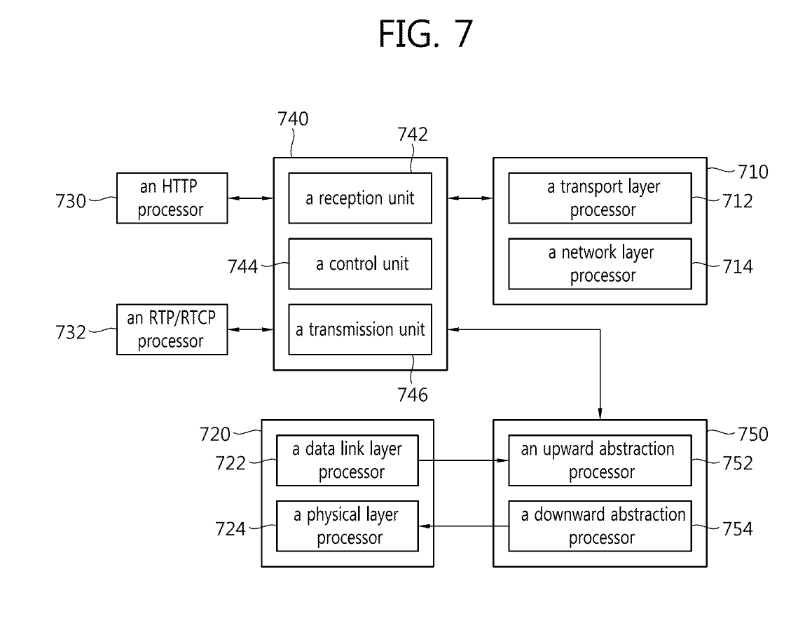

FIG. 7 is a block diagram illustrating a construction of a multimedia transmission system according to an embodiment of the present invention. As shown in FIG. 7, the multimedia transmission system 700 according to an embodiment of the present invention may include a first layer processing unit 710, a second layer processing unit 720, an HTTP processor 730, an RTP/RTCP processor 732, a multimedia transport processing unit 740 and an abstraction processing unit 750. Herein, each of the processing units 710, 720, 740 and 750 (and other processing units described herein) may be implemented as hardware processors, which are encoded to perform predetermined processing operations. For example, a processing unit may include or be a processor or logic circuit, such as an ASIC or an FPGA, that is programmed to perform processing operations as described herein.

Referring to FIG. 7, the first layer processing unit 710 may include a network layer processor 714 and a transport layer processor 712. The network layer processor 714 processes operations in a network layer, and the transport layer processor 712 processes operations in a transport layer.

The network layer processor 714 may be connected with an external network and control the associated network. Additionally, the network layer processor 714 may support the modification of a channel that is used for the multimedia data transmission, depending on a channel condition by transmitting service information to the multimedia transport processing unit 740.

The transport layer processor 712 may determine a multimedia transport channel based on the transport channel information that is suitable for the current properties among a plurality of transport channels of a communication network. The transport layer processor 712 may transmit the determined multimedia transport channel to the multimedia transport processing unit 740.

The second layer processing unit 720 may include a data link layer processor 722 and a physical layer processor 724. The data link layer processor 722 may process operations of the data link layer, and the physical layer processor 724 may process operations to be processed in the physical layer.

The data link layer processor 722 may perform various high speed wireless data packet communications, and may change a protocol that is used in accordance with the properties of the communication network from the time when multimedia data transmission starts to the time when the transmission is completed.

The physical layer processor 724 may receive information of characteristics and environments of radio medium from the wireless network, and may change the physical medium properties, depending on the information of characteristics and environments of wireless medium.

The reception of service information from the second layer processing unit 720 and indication information to the second layer processing unit 720 may be performed through the abstraction processing unit 750.

The HTTP processor 730 may process operations of an HTTP protocol, and the RTP/RTCP processor 732 may process operations of an RTP/RTPC protocol.

The multimedia transport processing unit 740 processes operations of the multimedia transport layer. The multimedia transport processing unit 740 may directly control the first layer processing unit 710, and may optimize the wireless network performance used for the multimedia transmission by controlling the second layer processing unit 720 through the abstraction processing unit 750. The multimedia transport processing unit 740 may include a reception unit 742, a control unit 744, and a transmission unit 746.

The reception unit 742 may receive service information from the first layer processing unit 710, the second layer processing unit 720, the HTTP processor 730, and the RTP/RTPC processor 732. For example, the service information from the second layer processing unit 720 may be received through the abstraction processing unit 750.

The control unit 744 generates indication information to provide a process optimized for the multimedia transmission by parsing the service information from each of layer processing units and processors 710, 720, 730, and 732 that are received from the reception unit 742.

The control unit 744 may define the multimedia transmission protocol based on the HTTP protocol or the RTP/RTCP protocol. Accordingly, the multimedia data, when transmitted based on the defined multimedia transmission protocol, may not change the multimedia transmission protocol according to the service information of lower layer.

In addition, the control unit 744 may select a transport channel through which multimedia data are transmitted based on the service information that is provided from a network layer processor 714. And, the control unit 744 may adjust the channel that is used for multimedia data transmission depending on the channel condition by adjusting the multimedia transmission protocol to select an optimal path that is used when the multimedia data is transmitted based on the service information that is provided by the network layer processor 714.

The control unit 744 may perform a cross-layer optimization based on the service information from the data link layer processor 722 and the physical layer processor 724.

The transmission unit 746 may transmit the indication information for each of layer processing units and processors 710, 720, 730, and 732 to each of layer processing units and processors 710, 720, 730, and 732 respectively.

Since the service information that is provided by the data link layer processor 722 and the physical layer processor 724 may take various forms according to communication methods that are selected by the data link layer processor 722 and the physical layer processor 724, the multimedia transport processing unit 740 may not detect all of these, and accordingly, may additionally be provided by the abstraction processing unit 750 that performs a function of mapping to the service information that may be used by the multimedia transport processing unit 740.

The abstraction processing unit 750 may include an upward abstraction processor 752 and a downward abstraction processor 754.

The upward abstraction processor 752 transmits the service information that is provided from the second layer processing unit 720 to the multimedia transport processing unit 740 by processing it into the form that is usable for the multimedia transport processing unit 740. The multimedia transport processing unit 740 may receive the service information, for example, medium characteristics such as a bandwidth that varies due to the characteristics or properties of a wireless channel and the occurrence of traffic concentration abruptly changing due to the characteristics or properties of a mobile communication network and a change in the number of users within a cell and a data transmission rate that varies depending on the characteristics and environment of radio medium. The multimedia transport processing unit 740 may perform the optimization of the first layer and second layer by using the service information processed.

The downward abstraction processor 754 provides the indication information that is received from the multimedia transport processing unit 740 to the second layer processing unit 720 after processing it. The indication information, for example, the transmission protocol (a standard of data, a transmission protocol, the amount of data per second, and so on) may be defined according to the type of multimedia data that is provided by the multimedia transport processing unit 740. The multimedia transport processing unit 740 may perform the optimization of the first layer and second layer by transmitting the indication information to the second layer processing unit 720 through the abstraction processing unit 750.

Although the preferred embodiments of the present invention have been described above, a person having ordinary skill in the art will appreciate that the present invention can be modified and changed in various ways without departing from the spirit and scope of the present invention which are written in the claims below.

1. A method performed by a multimedia transport system for transmitting multimedia data, the method comprising:
receiving, in a multimedia transport layer of the multimedia transport system, multimedia data to be transmitted to a receiver;
mapping, in an abstraction layer of the multimedia transport system that is in data communication with the multimedia transport layer, service information provided by a second layer of the multimedia transport system onto service information of the multimedia transport layer;
processing, in the abstraction layer, indication information provided by the multimedia transport layer that is based on the service information of the second layer;
providing the processed indication information to the second layer; and
transmitting, via a data link layer of the second layer, the multimedia data to the receiver based on the provided indication information, the multimedia data transmitted to the receiver having a data format and transmission protocol defined by the multimedia transport layer.

2. The method of claim 1, wherein the transmission protocol is defined based on HTTP protocol or RTP/RTCP protocol by the multimedia transport layer.

3. The method of claim 1, wherein the second layer provides service information that varies dynamically depending on characteristics of a communication network.

4. The method of claim 3, wherein the communication network is a network capable of transmitting and receiving multimedia data provided by the multimedia transport layer.

5. The method of claim 1, wherein the second layer changes, based on the indication information, service information that is provided when the multimedia data is transmitted to the receiver.

6. The method of claim 1, wherein the multimedia transport layer performs cross-layer optimization when the multimedia transport layer is applied to a mobile terminal and a Universal Mobile Telecommunication Network Terrestrial Radio Access Network (UMTS) wireless network.

7. A computer-readable storage medium whose contents, when executed by a computing system, cause the computing system to perform operations for transmitting multimedia data to a receiver, the operations comprising:
receiving, in a multimedia transport layer of the multimedia transport system, multimedia data to be transmitted to a receiver;
mapping, in an abstraction layer of the multimedia transport system that is in data communication with the multimedia transport layer, service information provided by a second layer of the multimedia transport system onto service information of the multimedia transport layer;
processing, in the abstraction layer, indication information provided by the multimedia transport layer that is based on the service information of the second layer;
providing the processed indication information to the second layer; and
transmitting, via a data link layer of the second layer, the multimedia data to the receiver based on the provided indication information, the multimedia data transmitted to the receiver having a data format and transmission protocol defined by the multimedia transport layer.
